(19) United States
(12) Patent Application Publication
(10) Pub. No.: US 2013/0078587 A1
(43) Pub. Date: Mar. 28, 2013

(54) MODULAR EPOXY CURING SYSTEM

(71) Applicants: Anthony J. Christopher, Andover, MA (US); George Ciolfi, Hampton, NH (US)

(72) Inventors: Anthony J. Christopher, Andover, MA (US); George Ciolfi, Hampton, NH (US)

(73) Assignee: kSARIA Corporation, Methuen, MA (US)

(21) Appl. No.: 13/402,310

(22) Filed: Feb. 22, 2012

Related U.S. Application Data
(60) Provisional application No. 61/540,271, filed on Sep. 28, 2011.

(51) Int. Cl. F27D 19/00; F27D 21/00; B25B 11/00

(52) U.S. Cl. 432/1; 269/37; 432/32; 432/51

(57) ABSTRACT

The present disclosure describes, among other things, a method. The method may include determining, by a processor of a controller, a setting on a control, the setting corresponding to a type of connector. The method may include retrieving, by the processor, an algorithm for curing epoxy disposed within the type of connector. The method may include generating, by the processor, at least one control signal based at least in part on the algorithm. The method may include sending, by the controller, the at least one control signal to a heating dock.

### RELATED APPLICATIONS

This application claims priority to U.S. Application No. 61/540,271, filed Sep. 28, 2011 and entitled, “Epoxy Dispensing Tool, Modular Epoxy Curing Tool, and Cleave Epoxy Removal Tool,” the contents of which are hereby incorporated by reference in their entirety.

### BACKGROUND

An optical fiber may be inserted into a connector (also referred to herein as a “terminus”) with an internal chamber filled with epoxy. The epoxy may be cured to secure the optical fiber within the connector.

### SUMMARY

In some aspects, the present disclosure is directed to an apparatus. The apparatus may include a heating conductor adapted to be coupled to a heat source in a heating dock. The apparatus may include connector holders disposed on the heating conductor, the connector holders adapted to secure connectors in position. The apparatus may include a thermal barrier disposed on the heating conductor. The apparatus may include cable holders disposed in cavities on an external surface of the thermal barrier, the cable holders adapted to secure in position coated optical fibers protruding from the connectors. The connector holders and the cable holders may be adapted to position the connectors along a length of the apparatus.

The heating conductor may include aluminum. The connectors secured by the connector holders may be equidistant from an axial center of the heating conductor. The connector holders may be adapted to secure ferrules of the connectors. The thermal barrier may include at least one of plastic, rubber, silicon, polytetrafluoroethylene (PTFE), and polyetherimide (PEI). The cable holders may include at least one of plastic, rubber, silicon, polytetrafluoroethylene (PTFE), and polyetherimide (PEI). The cable holders may be disposed in grooves within the cavities on the external surface of the thermal barrier. The apparatus may include a control to adjust the connector holders to secure connectors of different sizes.

In some aspects, the present disclosure is directed to another apparatus. The apparatus may include a controller comprising a control adapted for selecting a setting corresponding to a type of connector. The controller may be adapted to send control signals to a heating dock based at least in part on the setting. The control signals may be adapted for heating a heating dock according to an algorithm associated with curing epoxy disposed in the type of connector.

In some aspects, the present disclosure is directed to a method. The method may include determining, by a processor of a controller, a setting on a control, the setting corresponding to a type of connector. The method may include retrieving, by the processor, an algorithm for curing epoxy disposed within the type of connector. The method may include generating, by the processor, at least one control signal based at least in part on the algorithm. The method may include sending, by the controller, the at least one control signal to a heating dock.

Retrieving the algorithm may include retrieving at least one entry from a database based at least in part on the setting on the control. Retrieving the algorithm may include retrieving at least one of a ramp up period, control point, process set point, and process dwell time from the database based at least in part on the setting on the control. Retrieving the algorithm may include retrieving a first control point and a second control point for the algorithm. Retrieving the algorithm may include retrieving a first process dwell point and a second process dwell point for the algorithm.

Generating the at least one control signal may include generating at least one pulse of current at a predetermined frequency. Sending the at least one control signal to a heating dock may include sending the at least one control signal to a resistive heater in the heating dock.

The method may include receiving a signal including information about a temperature of at least a portion of the heating dock, and adjusting the at least one control signal based at least in part on the temperature.

In some aspects, the present disclosure is directed to another apparatus. The apparatus may include a controller comprising a memory storing algorithms for curing epoxy disposed in connectors, each algorithm corresponding to a different type of connector. The apparatus may include a heating dock. The apparatus may include a cord adapted to couple the controller and the heating dock. The cord may be adapted to enable the heating dock to cure epoxy in connectors in a remote location from the controller.

Each algorithm may include at least one of a ramp up period, control point, process set point, and process dwell time. Each algorithm may include a first control point and a second control point. Each algorithm may include a first process dwell point and a second process dwell point.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram of an exemplary modular epoxy curing system;

FIG. 2 is an image of an exemplary modular epoxy curing system;

FIG. 3 is a diagram of an exemplary fixture inserted into an exemplary heating dock of a modular epoxy curing system;

FIG. 4 is a diagram of an exemplary fixture of a modular epoxy curing system;

FIG. 5 is an image of an exemplary fixture of a modular epoxy curing system;

FIG. 6 is a cross-sectional view of exemplary cable holders and thermal barrier of a fixture of a modular epoxy curing system;

FIG. 7 is an image of an exemplary heating dock of a modular epoxy curing system;

FIG. 8 is an image of an exemplary fixture inserted into an exemplary heating dock of a modular epoxy curing system;

FIG. 9 is a diagram of an exemplary central controller of a modular epoxy curing system;

FIGS. 10 and 11 are depictions of trials for an exemplary temperature curing profile for a connector;

FIG. 12 is a table with parameters for temperature curing profiles for connectors;

FIG. 13 is a block diagram of exemplary computing devices usable in and/or with the controllers of the modular epoxy curing systems; and

FIG. 14 is a flow diagram of an exemplary method for determining a type of connector inserted into a fixture and selecting an algorithm for curing epoxy disposed in the type of connector.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In general overview, the present disclosure is directed to a modular epoxy curing system (also referred to herein as “curing system”). The curing system may enable an user to cure epoxy disposed within remotely located connectors. Curing the epoxy may solidify the epoxy. The curing system may be used to cure epoxy disposed within different types of connectors (e.g., connectors with different form factors and/or fabricated from different materials). The curing system may substantially reduce co-axial movement between a connector and an optical fiber disposed within an internal chamber of the connector while the system cures epoxy disposed within the connector. The curing system may substantially shield a coating (e.g., a cable jacket) of an optical fiber from heating applied to the connector to cure the epoxy disposed within the connector.

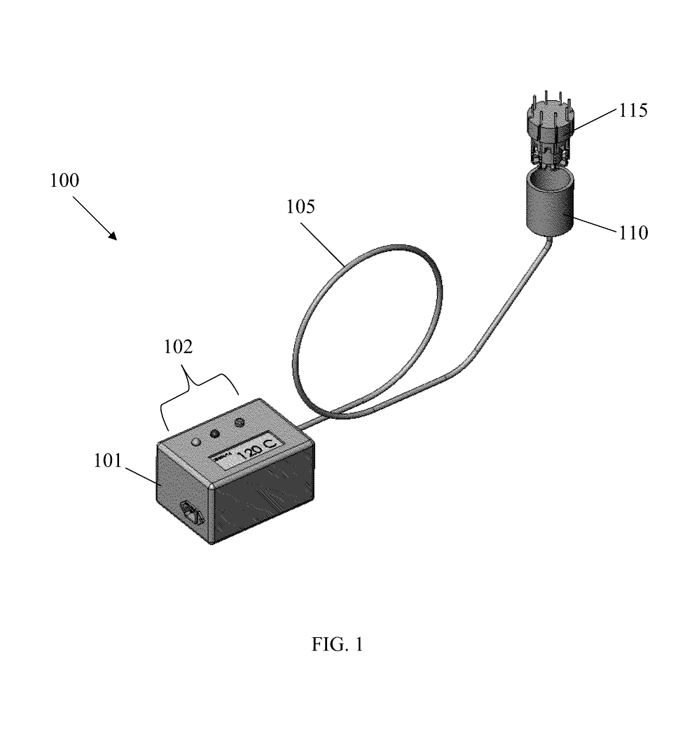

Referring now to FIG. 1, a diagram of an exemplary modular epoxy curing system 100 is shown and described. The modular epoxy curing system 100 may include a central controller 101 (also referred to herein as a “remote controller”). The central controller 101 may be coupled to at least one cord 105. The cord 105 may be coupled to a heating dock 110. In some implementations, the cord 105 may be a length that enables the heating dock 110 to be transported to a location remote from the central controller 101.

The central controller 101 may include an interface 102 with controls for operating the curing system 100. For example, the interface 102 may include one or more controls associated with selecting an algorithm according to which the heating dock 110 will be heated. In some implementations, the cord 105 may include one or more wires that carry control signals from the central controller 101 to the heating dock 110. The heating dock 110 may use the control signals to heat the dock 110.

In some implementations, the cord 105 may include wires that carry signals with information about the heating dock 110 from the heating dock 110 to the central controller 101. For example, the heating dock 110 may include a temperature sensor (not shown, and described in more detail below). The temperature sensor may determine the temperature of at least one location within the heating dock 110. The temperature sensor may send a signal containing information about the temperature through one or more wires in the cord 105 to the central controller 101. Thus, the central controller 101 may monitor a temperature of a location within the heating dock 110. In some implementations, the temperature sensor may be disposed on a surface of a heat source 140.

The curing system 100 may include a fixture 115. In some implementations, the fixture 115 may be adapted to accept and/or secure a plurality of connectors. In some implementations, the fixture 115 may be adapted to be inserted into the heating dock 110. In some implementations, the fixture 115 may be adapted to position each of the plurality of connectors at a constant distance from a heat source (not shown, and described in more detail below) in the heating dock 110.

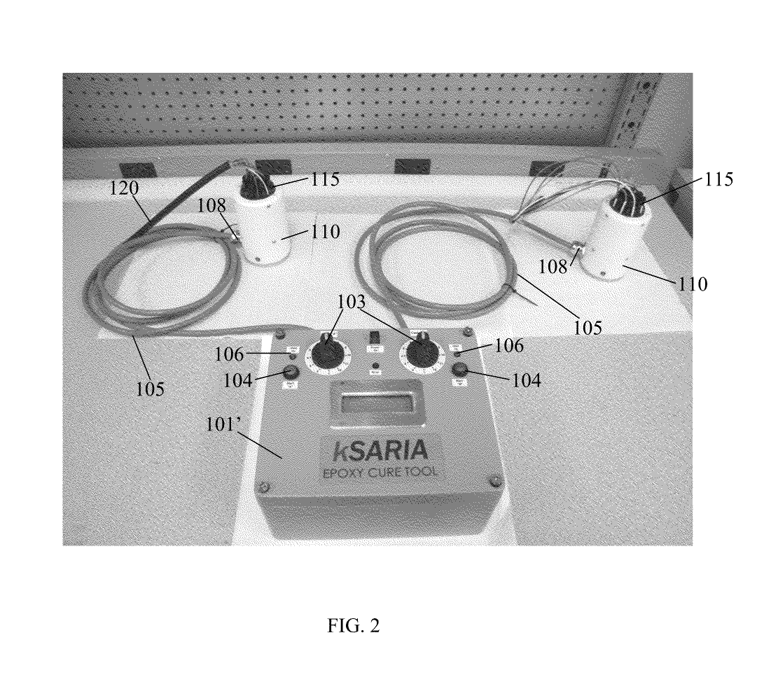

Referring now to FIG. 2, an image of an exemplary modular epoxy curing system is shown and described. The curing system includes a central controller 101′, two cords 105, and two heating docks 110. The central controller 101′ may include two control dials 103. Each control dial 103 may be coupled to a cord 105 and a heating dock 110. When a user turns a control dial 103 to a setting, the central controller 101′ may select an algorithm based on the setting. The central controller 101′ may retrieve the algorithm from a database based at least in part on the setting. The central controller 101′ may control heating of the heating dock 110 coupled to the control dial 103 according to the algorithm.

In some implementations, the central controller 101′ may include a control 104 associated with beginning an algorithm to heat a heating dock 110. In response to a user operating the control 104, the central controller 101′ may begin the algorithm associated with the setting of the control dial 103 coupled to the heating dock. In some implementations, the central controller 101′ may include an indicator 106 that indicates the status of an algorithm. For example, the central controller 101′ may power the indicator 106 such that the indicator 106 emits light while the central controller 101′ runs an algorithm to heat the heating dock 103 corresponding to the control dial 103. When the central controller 101′ completes the algorithm, the central controller 101′ may cease powering the indicator 106. Thus, an user of the curing system 100 may determine when the curing system 100 has completed a cycle for curing connectors and/or when the curing system 100 is available for use.

In some implementations, the central controller 101′ may continue powering the indicator 106 for a predetermined period of time after the algorithm has terminated. The central controller 101′ may power the indicator 106 until the temperature of the heat source 140 has dropped to a predetermined maximum temperature. When the heat source 140 is below the temperature, the central controller 101′ may cease powering the indicator 106. Thus, an user of the curing system 100 may determine when the curing system 100 has cooled to a temperature such that the fixture 115 may be safely removed and/or without further precautions by the user for handling the temperature of the fixture 115. In some implementations, the central controller 101′ may power the indicator 106 to indicate that the controller 101′ is controlling the heating dock 110.

Each cord 105 may be connected to a port 108 in the side of a heating dock 110. The port 108 may be coupled to a heat source 140 (not shown, and described in further detail below) in the heating dock 110.

In the image depicted in FIG. 2, a fixture 115 has been inserted in each heating dock 110. In some implementations, a fixture 115 may accept and/or secure eight connectors. In some implementations, a user may strip the coatings off optical fibers and insert each optical fiber into a separate connector with epoxy disposed therein. In some implementations, the portions of the optical fibers with remaining coatings may be bundled into a cable 120.

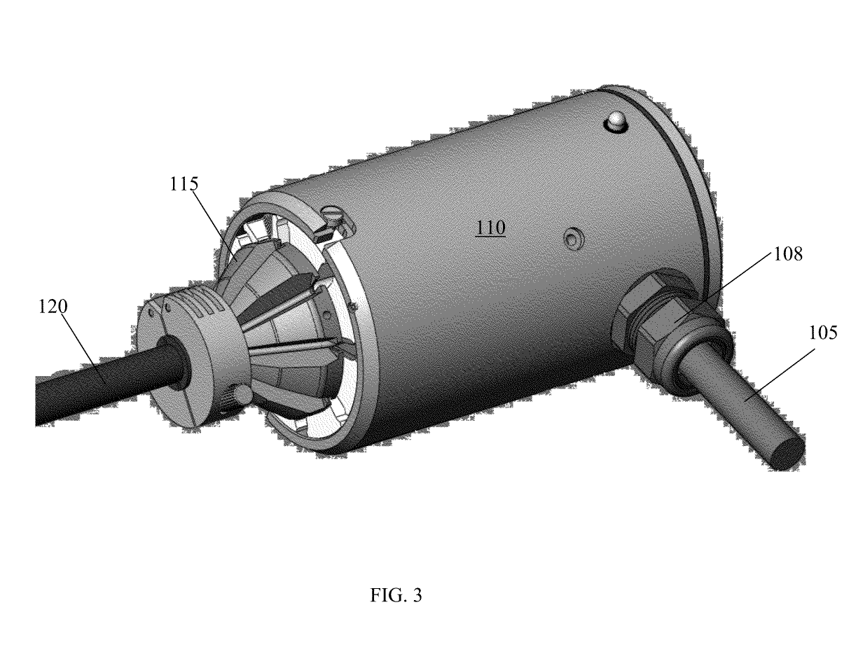

Referring now to FIG. 3, a diagram of an exemplary fixture 115 inserted into an exemplary heating dock 110 of a modular epoxy curing system is shown and described. In some implementations, a plurality of optical fibers may be bundled into a cable 120. The coating of each optical fiber in the cable may be stripped off, exposing the optical fiber. The optical fiber may be inserted into a connector with epoxy disposed therein. The connector may be secured in a fixture 115. The fixture 115 may be inserted into a heating dock 110 of a modular epoxy curing system 100. A cord 105 may connect to a port 108 in the side of the heating dock 110. Through this connection, the cord 105 may couple a heat source 140 (not shown) of the heating dock 110 to the central controller 101. Through the cord 105, the central controller 101 may send control signals to operate the heating core of the heating dock 110.

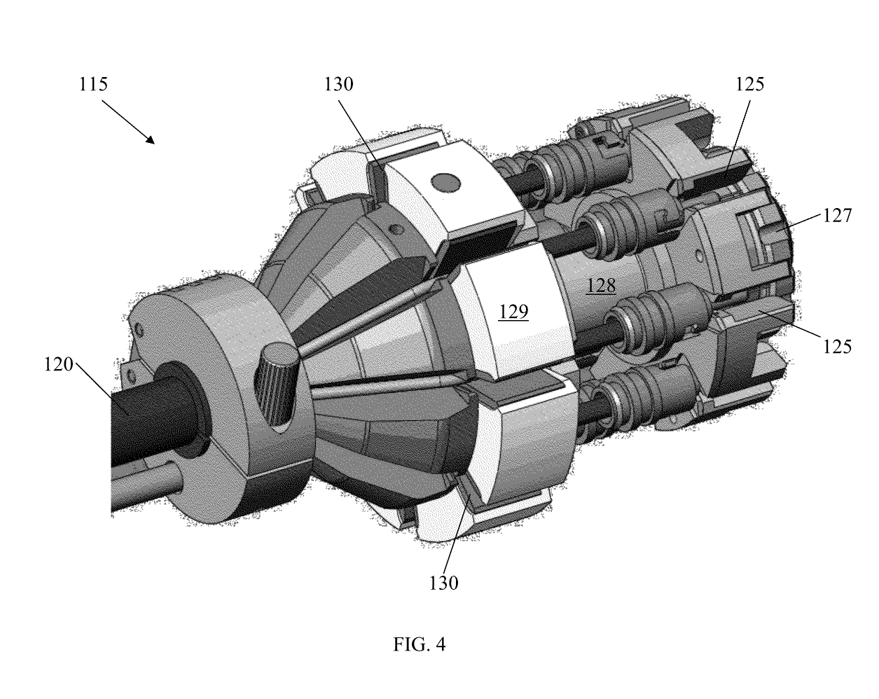

Referring now to FIG. 4, a diagram of an exemplary fixture 115 of a modular epoxy curing system is shown and described. The fixture 115 may include a plurality of connector holders 125 disposed on a heating conductor 128. Each connector holder 125 may be adapted to receive a ferrule of a connector. In some implementations, a connector holder 125 may be configured to have a shape corresponding to a cross-sectional area of a portion of a connector (e.g., the ferrule). Thus, the connector holder 125 may be adapted to enclose at least a portion of a connector. In some implementations, the connector holder 125 may include a pliable material adapted to accommodate various shapes of ferrules. In some implementations, a connector holder 125 may be a snap holder.

In some implementations, the connector holder 125 may include a resilient material. As a ferrule is inserted into the connector holder 125, the ferrule may push against a portion of the connector holder 125. The portion may absorb the force from the ferrule and exert a force against the ferrule to hold the ferrule in place. In some implementations, the connector holder 125 may include at least one of plastic, rubber, silicon, polytetrafluoroethylene (PTFE), and polyetherimide (PEI). In some implementations, the connector holder 125 may include steel and/or spring steel. In some implementations, the connector holder 125 may have a modulus of resilience of at least 30×10⁶ lb/in².

In some implementations, a connector holder 125 may include a spring connecting the halves of the connector holder 125. As a ferrule of a connector is inserted into the connector holder 125, the spring may exert a force against the ferrule as the ferrule pushes the halves of the connector holder 125 apart. Via this force, the connector holder 125 may hold the ferrule in place. In some implementations, each half of a connector holder 125 may include a spring. As a ferrule inserted into the connector holder 125 presses against the halves of the connector holder 125, the springs in the halves may exert forces against the ferrule to hold the ferrule in place.

In some implementations, the connector holder 125 may protect the optical fiber protruding from the ferrule of the connector. In some implementations, the connector holder 125 may include a cavity in which the optical fiber may reside when a ferrule has been inserted into the connector holder 125. In some implementations, the connector holder 125 may be a length such that an optical fiber protruding from the ferrule may reside within the connector holder. In some implementations, the connector holder 125 may be up to about 0.5 inches in length, although other lengths may be used. In some implementations, the connector holder 125 may be up to about 0.25 inches longer than the longest ferrule the fixture 115 has been designed to accommodate, although other lengths may be used. For example, if a fixture 115 is designed to accommodate a connector with a ferrule of about 0.375 inches, the connector holder 125 may be about 0.875 inches long. Thus, a user of the fixture may secure connectors with protruding optical fibers in a fixture 115 and set the fixture 115 on a surface, knowing that the cavities of the connector holders 125 may substantially shield the optical fibers from disturbance and potential damage.

In some implementations, the connector holder 125 may be adjusted to accommodate ferrules of different sizes. The fixture 115 may include a dial 127 coupled to the connector holders 125. By turning the dial 127, a user may operate the fixture 115 to increase or decrease the distance between halves of connector holder 125. In some implementations, as a user turns the dial 127, the fixture 115 adjusts the distances between halves of all of the connector holders 125 simultaneously.

In some implementations, the connector holders 125 may be adjusted to different positions along the exterior surface of the heating conductor 128. Thus, the fixture 115 may be adjusted to accommodate connectors of different lengths. In some implementations, an user of the fixture 115 may manually slide the connector holders 125 from one position on the heating conductor 128 to another. In some implementations, the fixture 115 may include a control (not shown) coupled to the connector holders 125. In response to user operation of the control, the control may slide the connector holders 125 along one direction or the alternate direction of the heating conductor 128. In some implementations, the control may be coupled to the dial 127. As a user turns the control, the control may operate to slide the connector holders 125 along one direction of the heating conductor 128. When the user turns the control in the opposite direction, the control may operate to slide the connector holders 125 along the other direction of the heating conductor 128.

In some implementations, the fixture 115 may include a heating conductor 128. The connector holders 125 and dial 127 may be disposed on the exterior surface of the heating conductor 128. In some implementations, the connector holders 125 may be disposed at equal distances from the heating conductor 128. For example, the connector holders 125 may be equidistant from an axial center of the heating conductor 128. Thus, connectors inserted into the connector holders 125 may be equidistant from the heating conductor 128.

When the fixture 115 is inserted into a heating dock 110, the heating conductor 128 may be coupled to a heat source 140 of the heating dock 110. In some implementations, the heating conductor 128 may include a cavity (e.g., a central opening) that extends through the length of the conductor 128. When the fixture 115 is inserted into a heating dock 110, the heat source 140 of the heating dock 110 may be inserted into the cavity. The conductor 128 may include a thermally conductive material. In some implementations, the thermally conductive material may be a metal, such as aluminum or copper.

When the conductor 128 is coupled to a heat source 140, the conductor 128 may conduct heat from the heat source 140. In some implementations, the conductor 128 includes a cylindrical shape. Thus, the conductor 128 may radially emanate heat conducted from the heat source. When the connector holders 125 are disposed equidistantly from the heat conductor 128, substantially similar amounts of energy may be radiated to connectors inserted into the connector holders 125. The heat may cure epoxy disposed within chambers of the connectors.

In some implementations, the fixture 115 may include a thermal barrier 129 disposed on the exterior surface of the heating conductor 128. The thermal barrier 129 may include cable holders 130 disposed on the exterior surface of the barrier 129 (e.g., disposed in cavities on the exterior surface). In some implementations, when the ferrule of a connector is inserted into a connector holder 125, at least a portion of the optical fiber with coating protruding from an end of the connector may be inserted into a cable holder 130.

In some implementations, the cable holder 130 may include a resilient material. For example, the cable holder 130 may include rubber, silicone, or any combination thereof. When a coated optical fiber is inserted into a cable holder 130, the cable holder 130 may exert a force around the coated optical fiber to hold the fiber in place. In some implementations, when the cable holder 130 holds a coated optical fiber in place and a connector holder 125 holds a connector in place, the cable holder 130 and connector holder 125 may operate in conjunction to substantially prevent axial movement between the connector and the optical fiber. Thus, the optical fiber may be held in a substantially constant position with respect to the connector as the epoxy disposed within the connector is being cured. In some implementations, the cable holder 130 may provide stress relief between the connector and the coated optical fiber protruding therefrom.

The thermal barriers 129 and cable holders 130 may include thermally insulating material. In some implementations, the thermally insulating materials may include plastic, rubber, silicon, polytetrafluoroethylene (PTFE) (which may be known commercially as Teflon, manufactured by DuPont Co. of Wilmington, Del.), polyetherimide (PEI) (which may be known commercially as Ultem Resin, manufactured by General Electric Company of Schenectady, N.Y.), or any other material in any combination. In some implementations, the thermally insulating materials may include elastomers.

The thermal barriers 129 and cable holders 130 may insulate the coated optical fibers from heat emanating from the heating conductor 128. As the temperatures needed to cure epoxy disposed within connectors may cause the coatings on optical fibers to melt, the thermal barriers 129 and cable holders 130 may protect the coatings when the epoxy is being cured.

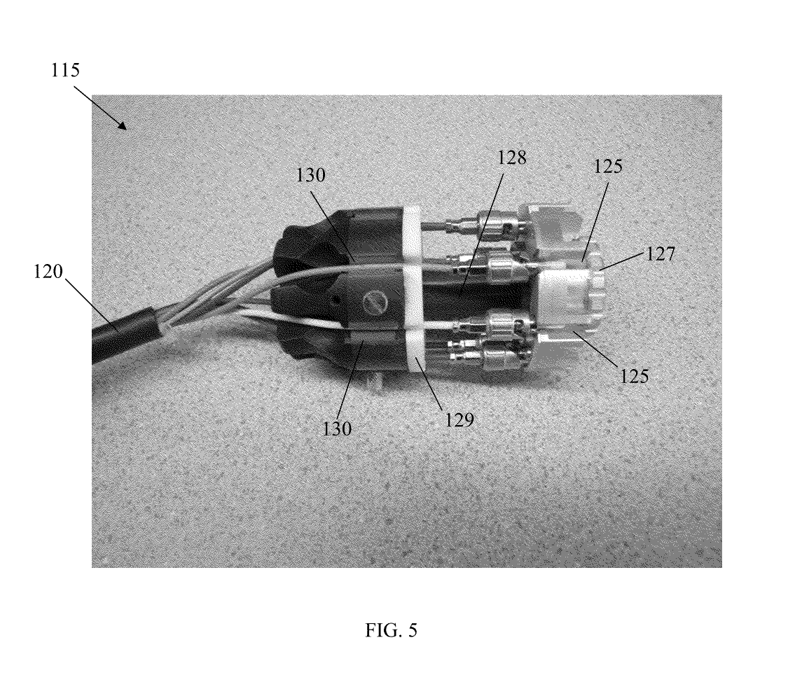

Referring now to FIG. 5, an image of an exemplary fixture of a modular epoxy curing system is shown and described. The fixture 115 includes a plurality of connector holders 125, each connector holder 125 securing a ferrule (e.g., a ceramic ferrule) of a connector in a position. The connector holders 125 may be equidistantly disposed from an axial center of a heating conductor 128. Thus, the connectors inserted into the connector holders 125 may be equidistant from the heating conductor 128 such that heat that is radially emanated from the conductor 128 may be substantially evenly distributed among the connectors. The fixture 115 may include a dial 127 that may be operated to increase or decrease the distance between the halves of the connector holders 125, thereby accommodating ferrules and/or connectors of varying sizes.

When coated optical fibers protruding from the connectors are inserted into the cable holders 130, the cable holders 130 may secure the position of the coated optical fibers. When the cable holders 130 secure the positions of the coated optical fibers and the connector holders 125 secure the positions of the ferrules and/or connectors, the cable holders 130 and connector holders 125 may substantially reduce co-axial movement between the connector and at least the portion of the optical fiber disposed within the internal chamber of the connector.

In some implementations, the cable holders 130 may be embedded in thermal barriers 129. The thermal barriers 129 and/or cable holders 130 may be disposed on an exterior surface of the heating conductor 128. The thermal barriers 129 and/or the cable holders 130 may insulate coated optical fibers inserted in the cable holders 130 from heat emanating from the heating conductor 128. The thermal barriers 129 and/or the cable holders 130 may prevent heat emanating from the heating conductor 128 from melting the coating on the optical fibers. In some implementations, the thermal barriers 129 and/or the cable holders 130 may insulate the coated optical fibers such that the temperature of the barriers 129 and/or holders 130 surrounding the coated optical fibers is about 60° C. or less.

In some implementations, the coated optical fibers may be bundled into a cable 120. In some implementations, a portion of the cable may be removed to expose the coated optical fibers. The coating on the optical fibers may be removed to expose the optical fibers. The optical fibers may be inserted into connectors with epoxy disposed therein. A portion of each coated optical fiber may be inserted into a cable holder 130 of the fixture 115. A portion of each ferrule of a connector may be inserted into a connector holder 125 of the fixture 115. Heating radially emanating from the heating conductor 128 may cure the epoxy disposed in the connector.

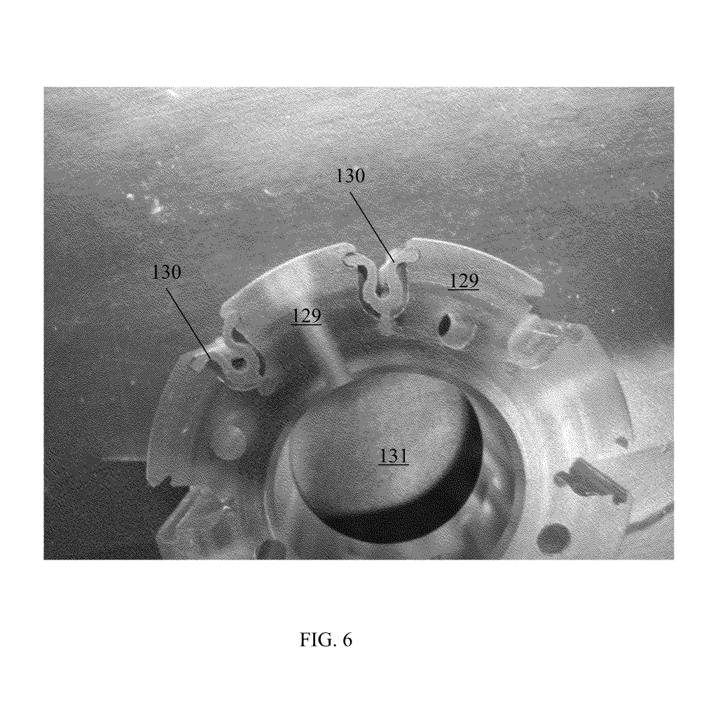

FIG. 6 is a cross-sectional view of exemplary cable holders and thermal barrier of a fixture of a modular epoxy curing system. The thermal barrier 129 may include a central opening 131 (e.g., a cavity). In some implementations, the thermal barrier 129 may be disposed on a heating conductor 128 of a fixture 115 by inserting the heating conductor 128 through the central opening 131. A user of the fixture 115 may manually adjust the position of the thermal barrier 129 on the heating conductor 128. In some implementations, automated machinery may insert the heating conductor 128 through the central opening 131 of the thermal barrier 129 and position the barrier 129 on the conductor 128.

In some implementations, cable holders 130 may be inserted into cavities of the thermal barrier 129. Each cavity in the thermal barrier 129 may include at least one groove. The at least one groove may be adapted to receive at least a portion of a cable holder 130. In some implementations, a cavity in the thermal barrier 129 may include three grooves. The three grooves may each be adapted to receive a different portion of a cable holder 130. When the portions of a cable holder 130 are inserted into the grooves of a cavity, the grooves may substantially secure the cable holder 130 within the cavity.

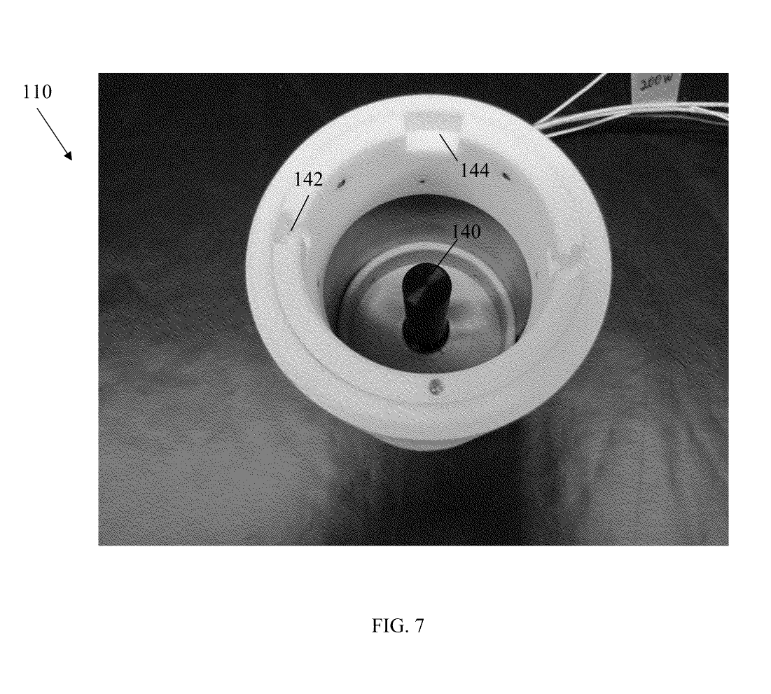

Referring now to FIG. 7, an image of an exemplary heating dock 110 of a modular epoxy curing system is shown and described. The heating dock 110 may include a heat source 140. When a fixture 115 is inserted into a heating dock 110, the heat source 140 may be inserted into a heating conductor 128 of the fixture 115. The heat source 140 may include any thermally conductive material. In some implementations, the heat source 140 may include at least one metal. In some implementations, the heat source 140 may include aluminum, steel, copper, or any combination thereof.

In some implementations, the heat source 140 may include a resistive heater (not shown). The resistive heater may be coupled to the port 108. When the cord 105 is connected to the port 108, the cord 105 may couple the resistive heater to the central controller 101. In some implementations, wires in the cord 105 may couple the resistive heater to the central controller 101.

In some implementations, the central controller 101 may send control signals through the cord 105 to the resistive heater. In some implementations, the control signals may include pulses of current. The pulses of current may be applied to the resistive heater, generating heat therein. In some implementations, the pulses of current may be run through the resistive heater to generate heat. The heat may increase the temperature of the resistive heater and thus, the heat source 140.

In some implementations, the heat source 140 may include a temperature sensor (not shown). The temperature sensor may be disposed on an external surface of the heat source 140. The temperature sensor may be disposed in an internal cavity of the heat source 140. The temperature sensor may be coupled to a wire connected to the port 108. When the cord 105 is connected to the port 108, the temperature sensor may be coupled to the central controller 101. The temperature sensor may send information about the temperature associated with the sensor's location to the central controller 101. In some implementations, the temperature sensor may send information about the temperature after a predetermined period of time has elapsed (e.g., every 20 seconds). In some implementations, the temperature sensor may send information about the temperature in response to a request from the central controller 101. Thus, the central controller 101 may monitor the temperature of the heat source 140.

The heating dock 110 may include interfaces 142, 144 through which the fixture 115 may be interlocked with the heating dock 110. In some implementations, after the fixture 115 has been inserted into the heating dock 110, a user may turn the fixture 115 to engage with the interfaces 142, 144. In some implementations, engaging the fixture 115 with the interfaces 142, 144 of the heating dock 110 may physically secure the fixture 115 to the heating dock 110 (e.g., place the fixture in a “locked” position).

In some implementations, the heating dock 110 may include a position sensor (not shown). The position sensor may determine the position of a fixture 115 inserted into the heating dock 110. In some implementations, the position sensor may determine if the fixture 115 has been physically secured in the heating dock 110. In some implementations, the position sensor may determine if the fixture 115 is in a locked position within the heating dock 110. The position sensor may be coupled to the port 108 such that connected to cord 105 to the port 108 may couple the position sensor to the central controller 101. In some implementations, the position sensor may send information about the position of the fixture 115 within the heating dock 110 to the central controller 101.

In some implementations, the central controller 101 may pre-condition sending control signals through the cord 105 to the resistive heater according to the position of the fixture 115. The central controller 101 may monitor information from the position sensor about the position of the fixture 115. Based on the information, the central controller 101 may determine whether the controller 101 shall send control signals to the resistive heater. For example, the central controller 101 may send control signals only when the information from the position sensor indicates the fixture 115 is physically secured in the heating dock 110 and/or in a locked position therein. In some implementations, if the information from the position sensor indicates the fixture 115 is not physically secured and/or in a locked position, the central controller 101 will not send control signals to heat the heat source 140.

In some implementations, the external surface of the heating dock 110 may include a thermally insulating material. The external surface may prevent heat generated within the heating dock 110 from emanating beyond the external surface. Thus, a user of the curing system 100 may handle the heating dock 110 while the heating dock 110 is curing epoxy disposed in connectors. In some implementations, the external surface of the heating dock 110 may include plastic, rubber, silicon, polytetrafluoroethylene (PTFE) (which may be known commercially as Teflon, manufactured by DuPont Co. of Wilmington, Del.), polyetherimide (PEI) (which may be known commercially as Ultem Resin, manufactured by General Electric Company of Schenectady, N.Y.), or any other material in any combination. In some implementations, the external surface of the heating dock 110 may include elastomers.

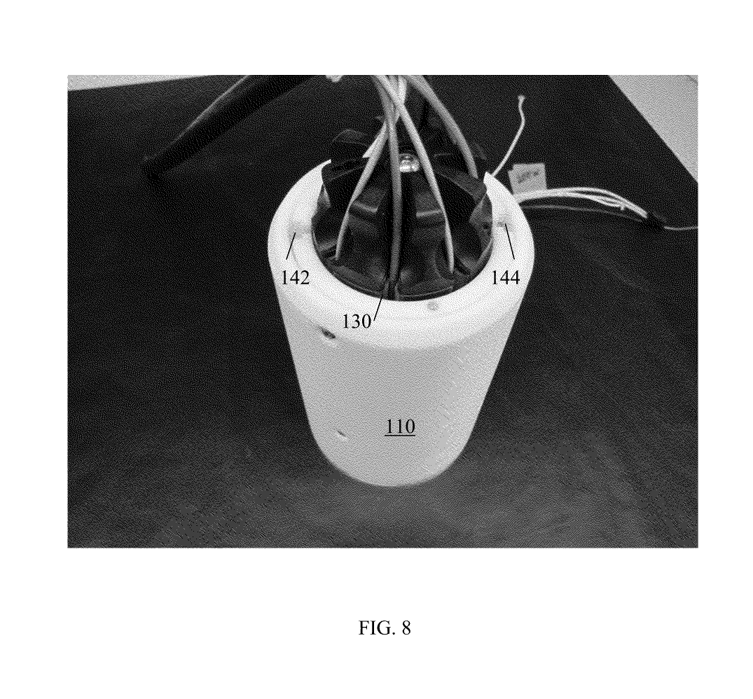

Referring now to FIG. 8, an image of an exemplary fixture 115 inserted into an exemplary heating dock 110 of a modular epoxy curing system is shown and described. In some implementations, connectors with optical fibers and epoxy disposed therein may be coupled to a fixture. The ferrules of the connectors may be inserted into the connector holders 130. At least a portion of the coated optical fibers protruding from the connectors may be inserted into the cable holders 130.

The fixture 115 with connectors may be inserted into a heating dock 110. In some implementations, as the fixture 115 is inserted into the heating dock 110, the heat source 140 of the heating dock 110 may be inserted into a central opening 131 of the heating conductor 128 of the fixture 115. In some implementations, an external diameter of the heat source 140 may be matched to an internal diameter of the central opening 131. In some implementations, a cross-sectional area and/or shape of the heat source 140 may be matched to the cross-sectional shape and/or area of the central opening 131. In some implementations, the thermal barrier 129 may be disposed on the fixture 115 such that the entire length of the thermal barrier 129 is disposed within the heating dock 110 when the fixture 115 is inserted therein. In some implementations, the thermal barrier 129 may be disposed to protrude from the heating dock 110 when the fixture 115 is inserted therein.

In some implementations, the fixture 115 may be turned to engage with the interfaces 142, 144 of the heating dock 110. In some implementations, engaging with the interfaces 142, 144 may physically secure the fixture 115 to the heating dock 110. In some implementations, engaging with the interfaces 142, 144 may configure the fixture 115 into a locked position within the heating dock 110. In some implementations, the heating dock 110 may into a position sensor to detect whether the fixture 115 has been physically secured within the heating dock 110. In some implementations, the position sensor may send information about the fixture's 115 position to a central controller 101. If the fixture 115 is not physically secured within the heating dock 110, the central controller 101 may not send control signals to heat the heat source 140.

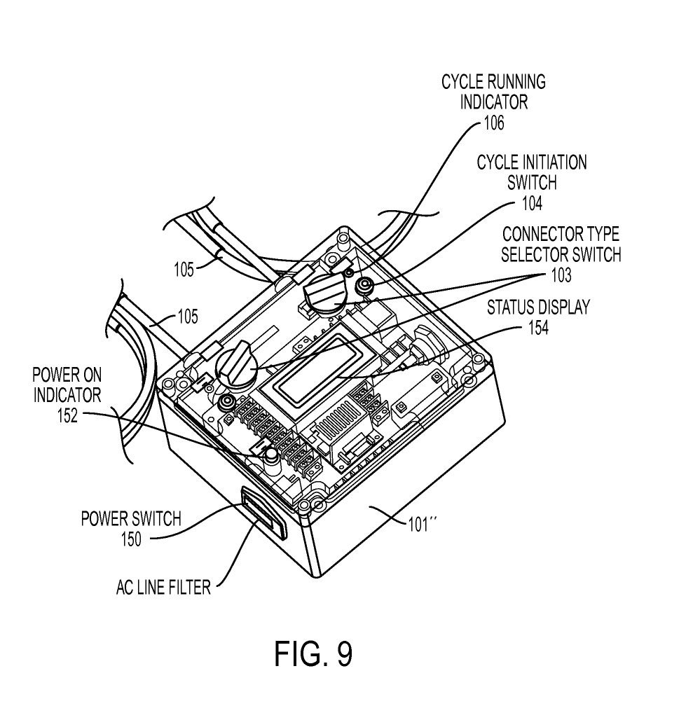

Referring now to FIG. 9, a diagram of an exemplary central controller 101″ of a modular epoxy curing system is shown and described. The central controller 101″ may include two control dials 103, as previously described herein. The central controller 101″ may include controls 104 associated with beginning algorithms to heat heating docks 110, as described herein. The central controller 101″ may include indicators 106 that indicate the status of an algorithm being applied to a heating dock 110, as described herein. The central controller 101″ may include a power switch 150. The central controller 101″ may include a power indicator 152. When the power switch 150 is in an on position, the central controller 101″ may send power to light up the power indicator 152.

In some implementations, the central controller 101″ may include a display 154. The display 154 may display information about the status of the central controller 101″. For example, the display 154 may display the identities of the connectors associated with the settings on the control dials 103. The display 154 may display the amount of time that has elapsed for an algorithm to cure epoxy being applied to a heating dock 110. The display 154 may display the amount of time remaining in an algorithm being applied to a heating dock 110. The display 154 may display information about the position of a fixture 115 in a heating dock 110. The information may be transmitted from a position sensor in the heating dock 110. The display 154 may display a temperature associated with a position of a temperature sensor in a heating dock 110.

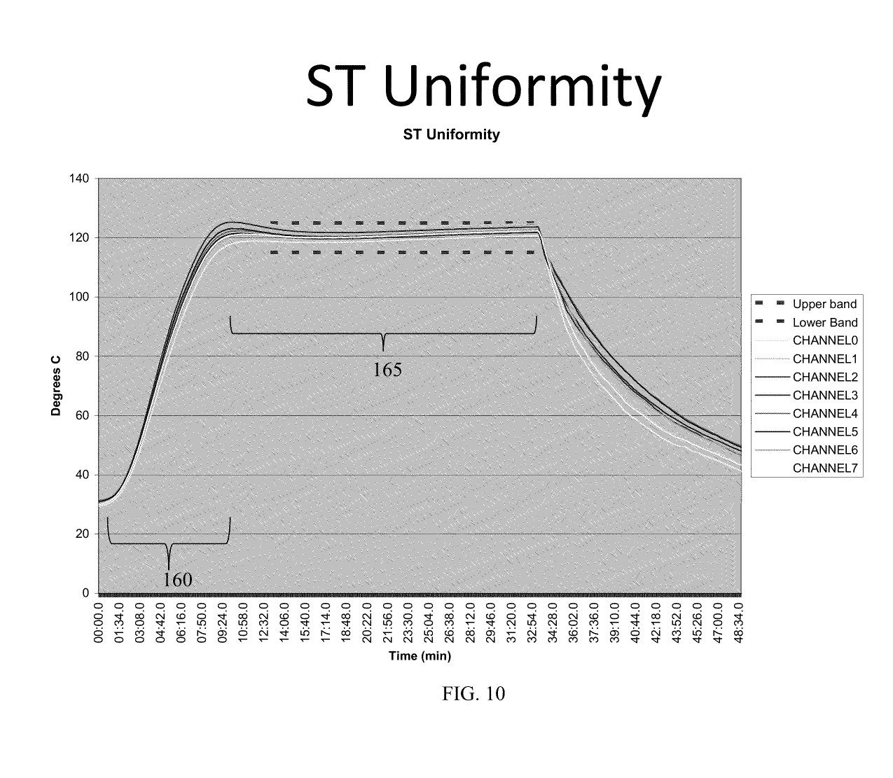

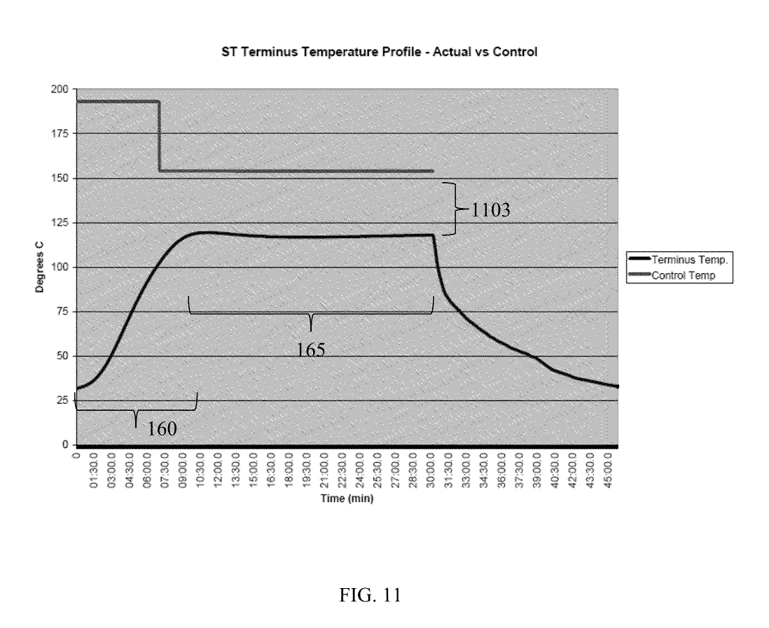

Referring now to FIGS. 10 and 11, depictions of trials for exemplary temperature curing profiles for connectors are shown and described. A temperature curing profile may include a progression of temperatures over time which may be used to cure epoxy disposed in a connector. As connectors may differ by form factor (e.g., size, weight), material (e.g., plastic, metal), and other factors, the temperature curing profiles corresponding to the connectors may vary to account for the differences between connectors.

Each temperature curing profile for a connector may contemplate a temperature at which epoxy disposed within the connector may be heated. Because the heat source 140 and/or heating conductor 128 may emanate heat radially to the connectors, at least a portion of the heat may dissipate before the heat reaches the epoxy. Thus, the temperature of the heat source 140 and/or heating conductor 128 may differ from the temperature of the epoxy (also referred to herein as an “offset” 1103).

A temperature curing profile may include a ramp up period 160. During the ramp up period 160, the central controller 101 may send control signals to the heating dock 110 to heat the dock 110 quickly to a control temperature (also referred to herein as the “control point”). The control temperature may be the target temperature for a surface of the heat source 140. In some implementations, a temperature lower than the control temperature may be the target temperature. In some implementations, the control temperature or a lower temperature may be the temperature to be maintained for the heat source 140 (also referred to herein as the “dwell temperature”). The control temperature and/or dwell temperature may be associated with a target curing temperature (also referred to herein as the “process set point”) for the epoxy disposed within connectors, located a predetermined distance away from the heat source 140. After the ramp up period, the central controller 101 may maintain the heat source 140 at the control point for a predetermined period of time to cure the epoxy (also referred to herein as the “process dwell time” 165). The ramp up period, control point, process set point, and/or process dwell time may be selected to cure epoxy disposed in a connector of a predetermined size, form factor, material, or any other factor.

In some implementations, during the ramp up period, the central controller 101 may send pulses of current at a high frequency through the resistive heater in the heat source 140. In some implementations, the central controller 101 may initially send a constant current through the resistive heater to heat the heat source 140 rapidly. In some implementations, the central controller 101 may send a constant current to the resistive heater for a predetermined period of time.

In some implementations, after the predetermined period of time has elapsed, the central controller 101 may begin sending pulses of current to the resistive heater. The central controller 101 may adjust the frequency of the pulses of current according to the amount of time that has elapsed in the curing algorithm, the information about the temperature in the heat source 140 received from the temperature sensor, or any other factor. In some implementations, after the ramp up period has elapsed, the central controller 101 may send pulses of current at a frequency selected in the algorithm. In some implementations, after the ramp up period has elapsed, the central controller 101 may monitor the information from the temperature sensor on the heat source 140. The central controller 101 may increase or decrease the frequency of the current pulses according to the information from the temperature sensor. The central controller 101 may increase or decrease the frequency of the current pulses to maintain the temperature of the heat source 140 at the control point.

In some implementations, a temperature curing profile may include a ramp up period of 6 minutes, 7 minutes, 8 minutes, or 9 minutes, although any other period of time may be used. In some implementations, a temperature curing profile may include a process dwell time of 20 minutes or 24 minutes, although any other period of time may be used. In some implementations, the entire duration of a temperature curing profile may be about 25 minutes, although any other period of time may be used. In some implementations, the offset between the control point of the heat source 140 and the process set point of the epoxy may be between about 30° F. and about 55° F. In some implementations, the offset may be about 34° F., about 36° F., about 38° F., about 41° F., about 45° F., or about 53° F.

In some implementations, a temperature curing profile may include a cooling period. The cooling period may allow the heat source 140 and/or the fixture 115 to cool to a substantially ambient room temperature. Thus, a user may remove the fixture 115 from the heating dock 110 without additional handling precautions. In some implementations, the central controller 101 does not send any current to the heat source 140 during the cooling period. Thus, the heat of the heat source 140 may be allowed to dissipate. In some implementations, the cooling period may be about 15 minutes, although other periods of time may be used.

In some implementations, the central controller 101 continues to power an indicator during the cooling period, thus indicating to a user that a cycle for the connectors has not terminated. In some implementations, the central controller 101 ceases to power the indicator after a predetermined period of time has elapsed. In some implementations, the central controller 101 continues to monitor the temperature of the heat source 140 via the temperature sensor. The central controller 101 may compare the temperature to a threshold. If the temperature exceeds the threshold, the central controller 101 may continue to power the indicator. If the threshold equals or exceeds the temperature, the central controller 101 may cease to power the indicator.

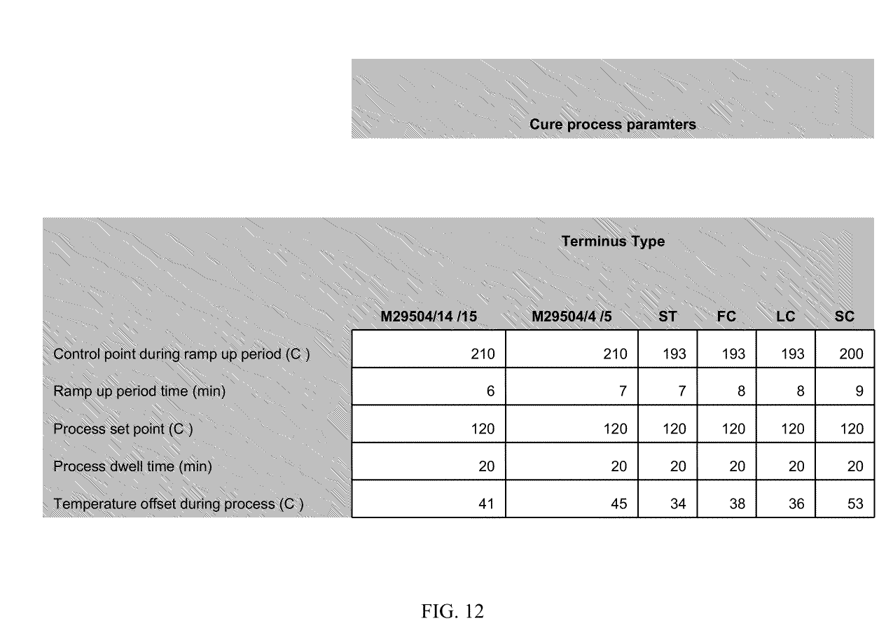

Referring now to FIG. 12, a table with parameters for temperature curing profiles for connectors is shown and described. The table includes temperature curing profiles for six types of connectors. The table includes the control points, ramp up periods, process set points, process dwell times, and temperature offsets for each of the temperature curing profiles.

The systems, software, and methods described herein may be implemented advantageously in one or more computer programs that are executable on a programmable system (e.g., the controller 101) including at least one programmable processor coupled to receive data and instructions from, and to transmit data and instructions to, a data storage system, at least one input device, and at least one output device. Each computer program may be implemented in a high-level procedural or object oriented programming language, or in assembly or machine language if desired. In any case, the language may be a compiled or interpreted language. Suitable processors include, by way of example, both general and special purpose microprocessors. Generally, a processor (e.g., one or more processors) will receive instructions and data from a read-only memory and/or a random access memory. Generally, a computer will include one or more mass storage devices for storing data files, such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD ROM disks. Any of the foregoing may be supplemented by, or incorporated in, ASICs (application-specific integrated circuits).

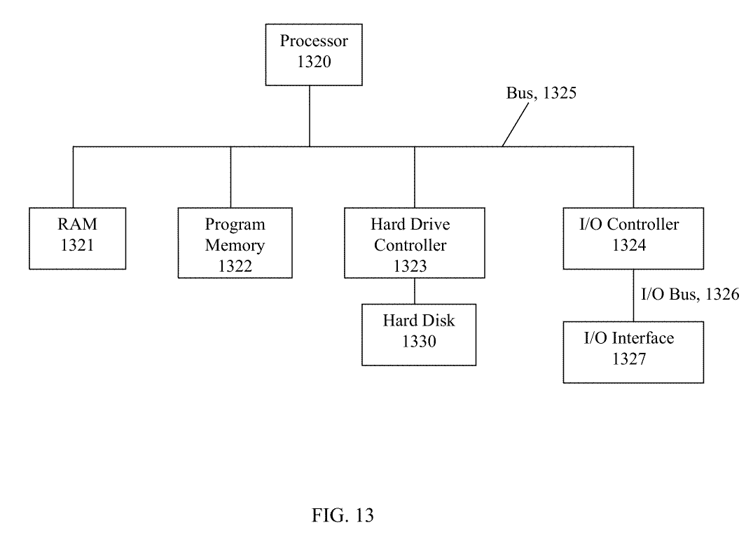

An example of one such type of computer is shown in FIG. 13, which shows a block diagram of a programmable processing system (system) 1300 suitable for implementing or performing the apparatus or methods described herein. The system 1311 includes a processor 1320, a random access memory (RAM) 1321, a program memory 1322 (for example, a writeable read-only memory (ROM) such as a flash ROM), a hard drive controller 1323, and an input/output (I/O) controller 1324 coupled by a processor (CPU) bus 1325. The system 1311 may be preprogrammed, in ROM, for example, or it can be programmed (and reprogrammed) by loading a program from another source (for example, from a floppy disk, a CD-ROM, external disk drive, USB key, or another computer).

The hard drive controller 1323 may be coupled to a hard disk 1330 suitable for storing executable computer programs, including programs embodying the present methods, and data including storage. The I/O controller 1324 may be coupled by an I/O bus 1326 to an I/O interface 1327. The I/O interface 1327 may receive and transmit data in analog or digital form over communication links such as a serial link, local area network, wireless link, and parallel link.

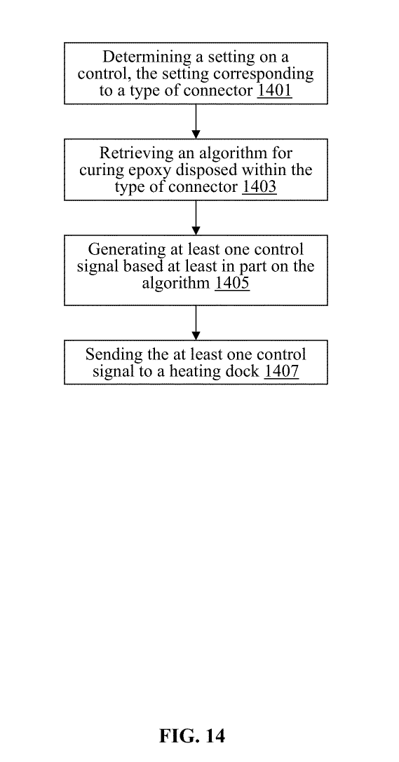

Referring now to FIG. 14, a flow diagram of an exemplary method for determining a type of connector inserted into a fixture and selecting an algorithm for curing epoxy disposed in the type of connector is shown and described. The method may include determining, by a processor of a controller, a setting on a control, the setting corresponding to a type of connector (step 1401). The method may include retrieving, by the processor, an algorithm for curing epoxy disposed within the type of connector (step 1403). The method may include generating, by the processor, at least one control signal based at least in part on the algorithm (step 1405). The method may include sending, by the controller, the at least one control signal to a heating dock (step 1407).

The method may include determining a setting on a control, the setting corresponding to a type of connector (step 1401). A processor may receive a signal from the control on an interface of the controller indicating the setting. In some implementations, the signal may be associated with a position of a control dial, as described herein. In some implementations, the signal may be associated with a selection of an entry in a menu. In some implementations, the signal may be associated with a selection of a button on an interface of a controller.

The method may include retrieving an algorithm for curing epoxy disposed within the type of connector (step 1403). A processor may access a database of algorithms for curing epoxy disposed in different types of connectors. A processor may retrieve an algorithm from the database. In some implementations, a processor may retrieve at least one entry from a database based at least in part on the setting on the control. In some implementations, the processor may retrieve an entry from the database corresponding to the algorithm based at least in part on the setting corresponding to the type of connector. In some implementations, the index of the entry may be associated with a position of a control dial, a position of an entry in a list of entries on a menu, or a position of a button on an interface of buttons, by way of example. In some implementations, the processor may retrieve at least one of a ramp up period, control point, process set point, and process dwell time from the database based at least in part on the setting on the control. The processor may retrieve any information associated with a temperature curing profile.

The method may include generating, by the processor, at least one control signal based at least in part on the algorithm (step 1405). In some implementations, the processor may generate at least one pulse of current at a predetermined frequency. The information about the algorithm from the database may include the predetermined frequency of the pulses. In some implementations, the algorithm may include the frequencies of the pulses of current and the periods of time for which the pulses of current should be generated at the frequencies.

The method may include sending, by the controller, the at least one control signal to a heating dock (step 1407). In some implementations, the controller may send the at least one control signal through a cord to a heating dock. The controller may send the at least one control signal to a resistive heater in a heat source in the heating dock.

While various implementations of the methods and systems have been described, these implementations are exemplary and in no way limit the scope of the described methods or systems. Those having skill in the relevant art may effect changes to form and details of the described methods and systems without departing from the broadest scope of the described methods and systems. Thus, the scope of the methods and systems described herein should not be limited by any of the exemplary implementations and should be defined in accordance with the accompanying claims and their equivalents.

What is claimed is:

1. An apparatus comprising:
a heating conductor adapted to be coupled to a heat source in a heating dock;
connector holders disposed on the heating conductor, the connector holders adapted to secure connectors in position;
a thermal barrier disposed on the heating conductor; and
cable holders disposed in cavities on an external surface of the thermal barrier, the cable holders adapted to secure in position coated optical fibers protruding from the connectors,
wherein the connector holders and the cable holders are adapted to position the connectors along a length of the apparatus.

2. The apparatus of claim 1, wherein the heating conductor comprises aluminum.

3. The apparatus of claim 1, wherein the connectors secured by the connector holders are equidistant from an axial center of the heating conductor.

4. The apparatus of claim 1, wherein the connector holders are adapted to secure ferrules of the connectors.

5. The apparatus of claim 1, wherein the connector holders are snap holders.

6. The apparatus of claim 1, wherein the thermal barrier comprises at least one of plastic, rubber, silicon, polytetrafluoroethylene (PTFE), and polyetherimide (PEI).

7. The apparatus of claim 1, wherein the cable holders comprise at least one of plastic, rubber, silicon, polytetrafluoroethylene (PTFE), and polyetherimide (PEI).

8. The apparatus of claim 1, wherein the cable holders are disposed in grooves within the cavities on the external surface of the thermal barrier.

9. The apparatus of claim 1, further comprising a control to adjust the connector holders to secure connectors of different sizes.

10. An apparatus comprising:
a controller comprising a control adapted to select a setting corresponding to a type of connector,
wherein the controller is adapted to send control signals to a heating dock based at least in part on the setting, and
wherein the control signals are adapted to heat a heating dock according to an algorithm associated with curing epoxy disposed in the type of connector.

11. A method comprising:
determining, by a processor of a controller, a setting on a control, the setting corresponding to a type of connector;
retrieving, by the processor, an algorithm for curing epoxy disposed within the type of connector;
generating, by the processor, at least one control signal based at least in part on the algorithm; and
sending, by the controller, the at least one control signal to a heating dock.

12. The method of claim 11, wherein retrieving the algorithm comprises:
retrieving, by the processor, at least one entry from a database based at least in part on the setting on the control.

13. The method of claim 11, wherein retrieving the algorithm comprises:
retrieving, by the processor, at least one of a ramp up period, control point, process set point, and process dwell time from the database based at least in part on the setting on the control.

14. The method of claim 11, wherein retrieving the algorithm comprises:
retrieving, by the processor, a first control point and a second control point for the algorithm.

15. The method of claim 11, wherein retrieving the algorithm comprises:
retrieving, by the processor, a first process dwell point and a second process dwell point for the algorithm.

16. The method of claim 11, wherein generating the at least one control signal comprises:
generating at least one pulse of current at a predetermined frequency.

17. The method of claim 11, wherein sending the at least one control signal to a heating dock comprises:
sending the at least one control signal to a resistive heater in the heating dock.

18. The method of claim 11, further comprising:
receiving, by the processor, a signal including information about a temperature of at least a portion of the heating dock; and
adjusting, by the processor, the at least one control signal based at least in part on the temperature.

19. An apparatus comprising:
a controller comprising a memory storing algorithms for curing epoxy disposed in connectors, each algorithm corresponding to a different type of connector;
a heating dock; and
a cord adapted to couple the controller and the heating dock, wherein
the cord is adapted to enable the heating dock to cure epoxy in connectors in a remote location from the controller.

20. The apparatus of claim 19, wherein each algorithm comprises at least one of a ramp up period, control point, process set point, and process dwell time.

21. The apparatus of claim 19, wherein each algorithm comprises a first control point and a second control point.

22. The apparatus of claim 19, wherein each algorithm comprises a first process dwell point and a second process dwell point.
